(19) United States
(12) Patent Application Publication
(10) Pub. No.: US 2019/0253438 A1
(43) Pub. Date: Aug. 15, 2019

(54) Analysis Method for Network Flow and System

(71) Applicant: Go-idea Ltd., Taichung City (TW)

(72) Inventors: Che-Hung Yeh, Tainan City (TW); Jian-Ting Huang, Taichung City (TW); Yueh-Feng Lin, Taichung City (TW)

(21) Appl. No.: 15/990,703

(22) Filed: May 28, 2018

(30) Foreign Application Priority Data
Feb. 13, 2018 (TW) 107105258

(51) Int. Cl. H04L 29/06; H04L 12/26

(52) U.S. Cl. CPC H04L 63/1416; H04L 43/0894; H04L 63/1458; H04L 63/101; H04L 63/1491

(57) ABSTRACT

An analysis method for a network flow includes retrieving a source IP address and a destination IP address of the network flow; determining whether the destination IP address qualifies a pre-determined condition or not; and determining whether the source IP address is in a white list or the destination IP address is in an activity IP address list when the destination IP address does not qualify the pre-determined condition, so as to determine whether the network flow belongs to an attack behavior or not.

### BACKGROUND OF THE INVENTION

### 1. Field of the Invention

The present invention relates to an analysis method of network flow and computer system thereof, and more particularly, to an analysis method of network flow and computer system thereof capable of determining types of the network flow.

### 2. Description of the Prior Art

With the advancement and improvement of technology, dependency of people on the internet is increasing, and consequently, safety issues over the internet are arisen. For example, distributed denial of service (DDoS) attack is one of common attack events on the internet, which sends out a large amount of internet packets of service requests to attack servers or computer systems, causes malfunction of the servers or computer systems, and further occupies resources, bandwidths and even breaks down the network system or so. However, conventional protective measurements for the attack events on the internet are not well-rounded, and the attack events on the internet are random and unpredictable. Therefore, when the attack events occur, a reaction time might be tens of minutes to hours, which damages the safety of the internet. As such, an analysis for the network flow is a must to instantaneously filter a suspicious network flow and effectively prevent occurrence of the attack events on the internet. In addition, the conventional analysis for the network flow requires a long time to finish a process of the analysis for the network flow, which cannot filter the suspicious network flow instantaneously.

Therefore, how to solve the above mentioned problems to effectively and instantaneously provide an analysis method for the network flow, so as to improve the protection efficiency on the internet, has become one of important issues in the field.

### SUMMARY OF THE INVENTION

Therefore, the present invention provides an analysis method for the network flow and a computer system thereof to effectively analyze the network flow and prevent the attack events on the internet.

The present invention discloses an analysis method for a network flow, comprising retrieving a source IP address and a destination IP address of the network flow; determining whether the destination IP address qualifies a pre-determined condition or not; and determining whether the source IP address is in a white list or the destination IP address is in an activity IP address list when the destination IP address does not qualify the pre-determined condition, so as to determine whether the network flow belongs to an attack behavior or not.

The present invention further discloses a computer system, comprising at least a router, for determining a path of a network flow; a collector, for collecting a destination IP address and a source IP address of the path of the network flow; and an analyzer, for retrieving the source IP address and the destination IP address of the network flow, determining whether the destination IP address qualifies a pre-determined condition or not, and determining whether the source IP address is in a white list or the destination IP address is in an activity IP address list when the destination IP address does not qualify the pre-determined condition, so as to determine whether the network flow belongs to an attack behavior or not.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIGS. 2-4 are schematic diagrams of an analysis process according to an embodiment of the present invention.

### DETAILED DESCRIPTION

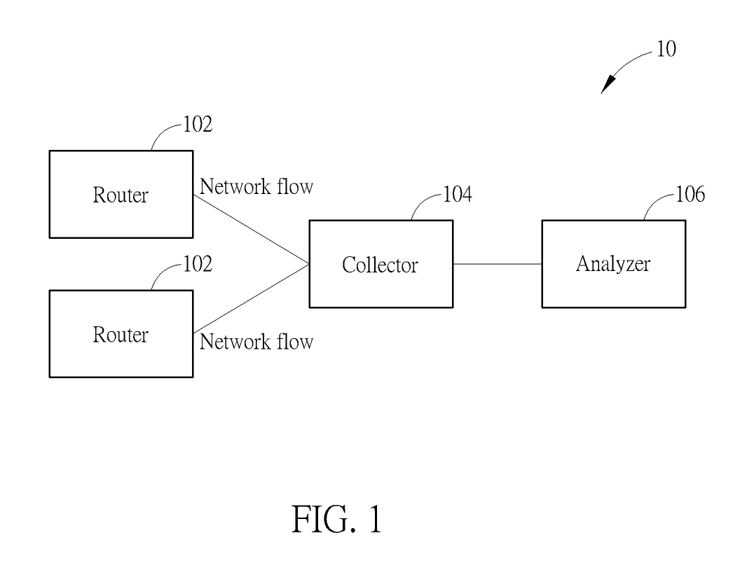

Please refer to FIG. 1, which is a schematic diagram of a computer system 10 according to an embodiment of the present invention. The computer system 10 includes a plurality of routers 102, a collector 104 and an analyzer 106. The computer system 10 may be utilized for analyzing a network flow, so as to perform steps of detection, recognition, categorization, blocking or so for the network flow, and to determine whether the network flow belongs to an attack behavior or not. When determining that the network flow belongs to the attack behavior, the computer system 10 informs an operator or an application program interface (API) of calling an application delivery controller (ADC) to automatically direct the network flow to a special network cluster and calling a router to adjust a routing table, so as to prevent the network from the attack. The routers 102 are utilized for determining a path of the network flow, the collector 104 is utilized for aggregating or collecting a destination IP address and a source IP address related to the path of the network flow, and the analyzer 106 is utilized for retrieving the destination IP address of the network flow, so as to determine whether the destination IP address qualifies a pre-determined condition or not accordingly. When the destination IP address qualifies the pre-determined condition, the computer system 10 determines whether the source IP address is in a white list or the destination IP address is in an activity IP address list or not, so as to confirm whether the attack behavior is lasting or not.

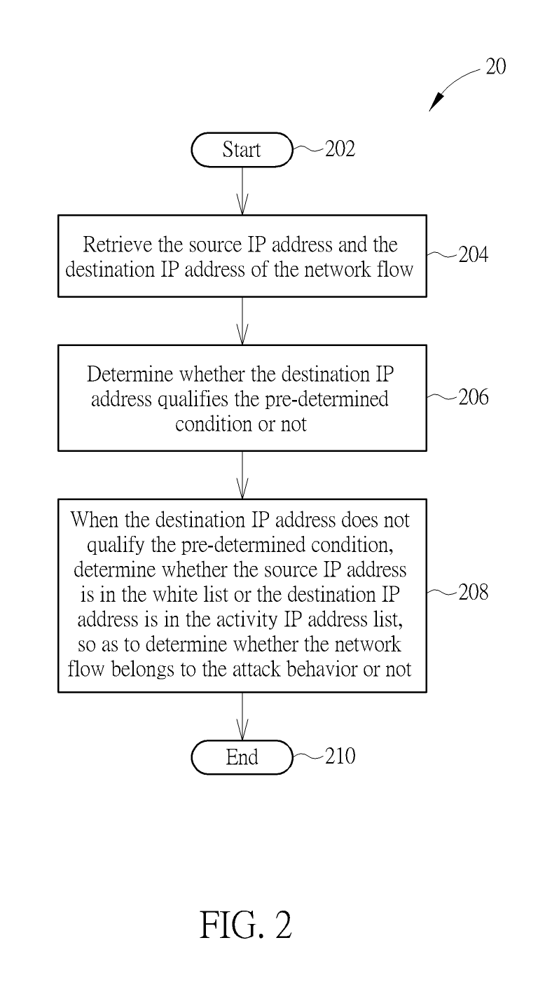

In detail, please refer to FIG. 2, which is a schematic diagram of an analysis process 20 according to an embodiment of the present invention. The analysis process 20 may be applied to the computer system 10, so as to perform the steps of detection, recognition, categorization, blocking or so for the network flow. The analysis process 20 includes the following steps:

Step 202: Start.

Step 204: Retrieve the source IP address and the destination IP address of the network flow.

Step 206: Determine whether the destination IP address qualifies the pre-determined condition or not.

Step 208: When the destination IP address does not qualify the pre-determined condition, determine whether the source IP address is in the white list or the destination IP address is in the activity IP address list, so as to determine whether the network flow belongs to the attack behavior or not.

Step 210: End.

Based on the analysis process 20, the computer system 10 may determine whether the network flow belongs to the attack behavior or not according to the destination IP address of the network flow. First, in step 204, the analyzer 106 of the computer system 10 retrieves the destination IP addresses of the network flow collected by the collector 104, so as to determine whether the network flow qualifies the pre-determined condition or not according to the destination IP addresses in step 206. In an embodiment, the pre-determined condition is that a packet per second, a flow count or a bit number transmitted to a same destination IP address exceeds a threshold. Therefore, when the analyzer 106 examines that the packet per second, the flow count or the bit number transmitted to the same destination IP address exceeds the threshold, the analyzer 106 sends out an alarm and informs a network operation center. In addition, when the destination IP address does not qualify the pre-determined condition, in step 208, the analyzer 106 further determines whether the source IP address is in the white list or the destination IP address is in the activity IP address list, so as to confirm whether the network flow belongs to the attack behavior or not. In this example, the network operation center is in which the operator monitors and controls the network. Moreover, when the destination IP address qualifies the pre-determined condition, the analyzer 106 retains the network flow in a database for reference. Notably, the thresholds of each kind of the pre-determined conditions may be adjusted according to the requirements of the computer system or the operator, for example, sending out the alarm when the packet per second transmitted to the same destination IP address is over 100 MB, or when the bit number transmitted to the same destination IP address is over 1 GB, but not limited thereto, and can all be applied to the present invention.

The example stated above briefly illustrates that the computer system of the present invention determines whether the destination IP address of the network flow qualifies the pre-determined condition, so as to determine whether the network flow belongs to an attack event or not; therefore, measurements may be taken in advance to prevent the network from attack. Notably, those skilled in the art may make proper modifications to the present invention according to different system requirements. For example, one or more pre-determined conditions may be adopted to determine whether the network flow belongs to the attack event or not, or other indications included in the network flow may also be adopted to determine whether the network flow belongs to the attack event or not, and not limited thereto, which all belong to the scope of the present invention.

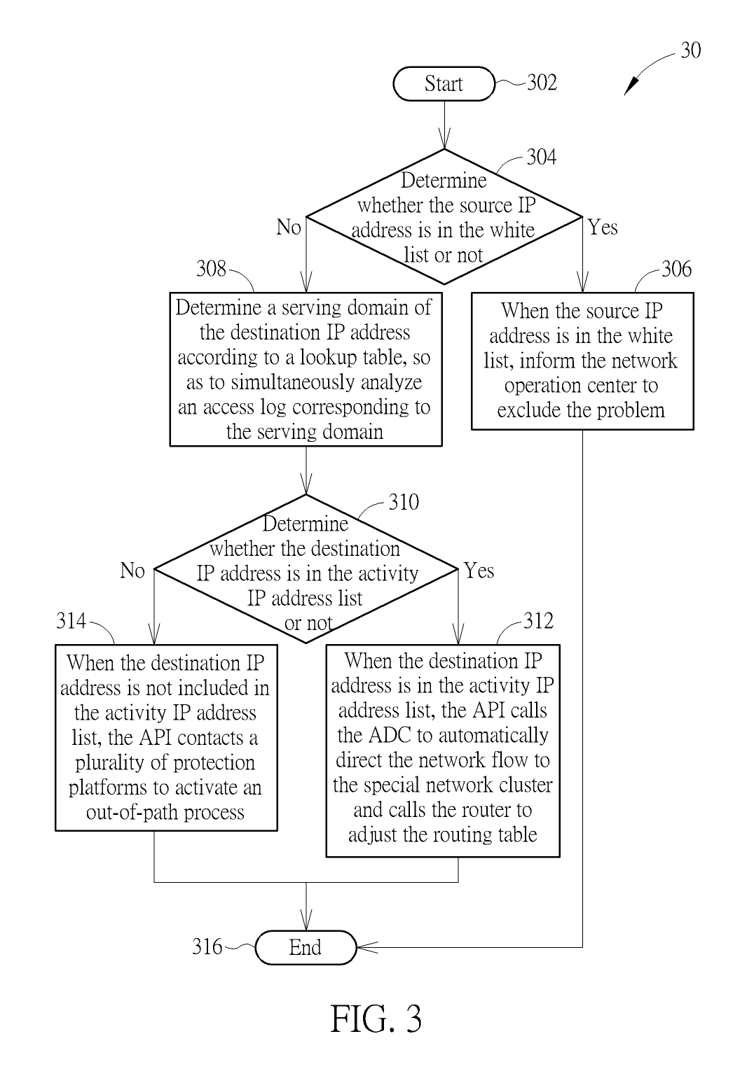

In an embodiment, when the destination IP address of the network flow does not qualify the pre-determined condition, the analyzer 106 may further determine whether the source IP address is in the white list or not or the destination IP address is in the activity IP address list or not, so as to execute a corresponding measurement. Please refer to FIG. 3, which is a schematic diagram of an analysis process 30 according to an embodiment of the present invention. The analysis process 30 includes the following steps:

Step 302: Start.

Step 304: Determine whether the source IP address is in the white list or not. If yes, execute step 306; if not, execute step 308.

Step 306: When the source IP address is in the white list, inform the network operation center to exclude the problem.

Step 308: Determine a serving domain of the destination IP address according to a lookup table, so as to simultaneously analyze an access log corresponding to the serving domain.

Step 310: Determine whether the destination IP address is in the activity IP address list or not. If yes, execute step 312; if not, execute step 314.

Step 312: When the destination IP address is in the activity IP address list, the API calls the ADC to automatically direct the network flow to the special network cluster and calls the router to adjust the routing table.

Step 314: When the destination IP address is not included in the activity IP address list, the API contacts a plurality of protection platforms to activate an out-of-path (OOP) process.

Step 316: End.

Based on the analysis process 30, the computer system 10 may execute the corresponding measurement according to whether the source IP address of the network flow is in the white list or not, or whether the destination IP address is in the activity IP address list or not. First, in step 304, the analyzer 106 determines whether the source IP address is in the white list or not. When the source IP address is in the white list, the analyzer 106 executes step 306 to inform the network operation center excluding the problem. In contrast, the analyzer 106 executes step 308 to determine the serving domain of the destination IP address by the lookup table, and instantaneously analyzes the access log corresponding to the serving domain. That is, the access log of the serving domain is instantaneously analyzed to determine whether the network flow provided by the serving domain is a suspicious network flow or not. Then, in step 310, the analyzer 106 determines whether the destination IP address is in the activity IP address list or not. If the destination IP address is included in the activity IP address list, the analyzer 106 executes step 312. The API calls the ADC to automatically direct the network flow to the special network cluster and calls the router to adjust the routing table. On the contrary, when the destination IP address is not included in the activity IP address list, the analyzer 106 executes step 314, the API contacts the protection platforms to activate the OOP process. More specifically, the OOP process directs the network flow to an out-of-path system to filter attack packets and direct the network flow back to a server. As such, the computer system 10 performs the OOP process for the network flow, which belongs to the attack behavior, based on the analysis process 30, to prevent the network from continuously suffering the attack behavior.

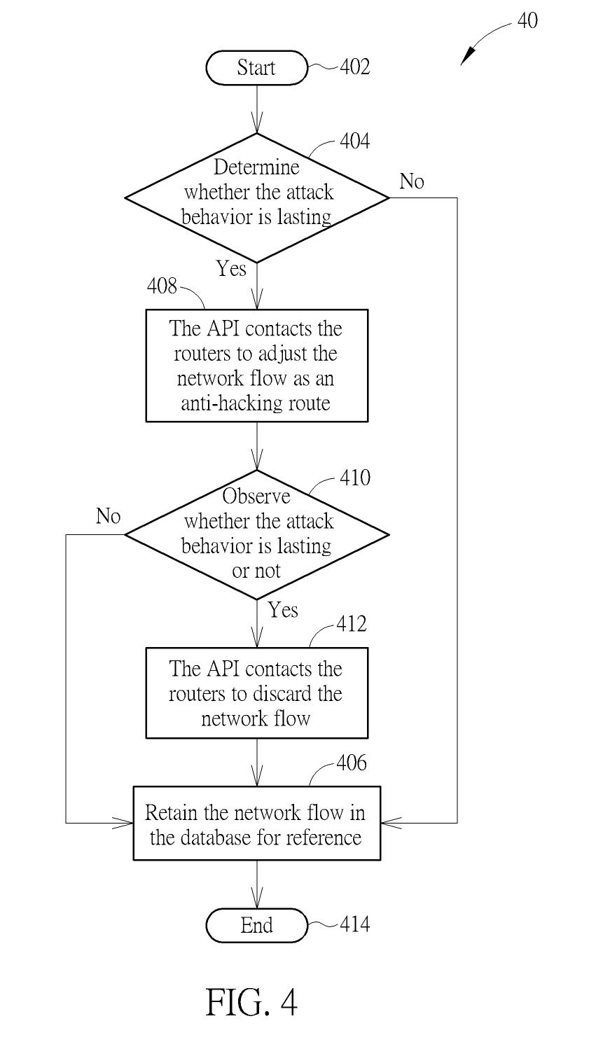

As can be known from the above, based on the analysis processes 20 and 30, the computer system 10 performs steps of the detection, recognition, determination, categorization and so on to simultaneously determine whether the network flow belongs to the attack behavior or not, and to activate the OOP process to prevent the computer system 10 from the attack. In another embodiment, after the analyzer 106 activates the OOP process to filter the attack packets of the network flow, the analyzer 106 keeps observing whether the attack behavior is lasting or not. Please refer to FIG. 4, which is a schematic diagram of an analysis process 40 according to an embodiment of the present invention. The analysis process 40 includes the following steps:

Step 402: Start.

Step 404: Determine whether the attack behavior is lasting. If yes, execute step 408; if no, execute step 406.

Step 406: Retain the network flow in the database for reference.

Step 408: The API contacts the routers 102 to adjust the network flow as an anti-hacking route.

Step 410: Observe whether the attack behavior is lasting or not. If yes, execute step 412; if not, execute step 406.

Step 412: The API contacts the routers 102 to discard the network flow.

Step 414: End.

Based on the analysis process 40, the computer system 10 may further analyze the network flow by the OOP process. In step 404, the computer system 10 determines whether the attack behavior is lasting or not. If the computer system 10 is not suffering the attack, the computer system 10 executes step 406 to retain the network flow in the database for reference. In contrast, if the attack behavior keeps ongoing, the computer system 10 executes step 408 to contact the routers 102 by the API to adjust the network flow as the anti-hacking route. In other words, the path of the network flow is adjusted to the path of the anti-hacking route, so as to prevent the computer system 10 from suffering the attack continuously. Then, in step 410, the computer system 10 observes whether the attack behavior is lasting or not. When the attack is lasting, the computer system 10 contacts the routers 102 by the API to discard the network flow, or adjusts the network flow as a black hole route.

Notably, the above mentioned embodiments are to illustrate the concept of the present invention, those skilled in the art may make proper modifications to the present invention according to different system requirements, and not limited thereto. According to different applications and design concepts, the analysis method for the network flow and the computer system may be implemented in all kinds of methods. Compared to the above mentioned analysis based on the destination IP address of the network flow, in another embodiment, the source IP address of the network flow may also be utilized for analysis. For example, the analyzer 106 may determine whether the network flow is in an IP reputation list or not according to the source IP address of the network flow, so as to direct the network flow to a honey pot system by the API when the source IP address is in any IP reputation list. Or, when the source IP address is not in any IP reputation list, the analyzer 106 may retain the source IP address and the destination IP address in the database for reference. These alternations all belong to the scope of the present invention.

In summary, the present invention provides an analysis method for the network flow and a computer system thereof capable of instantaneously analyzing the network flow according to multiple indications of the network flow, so as to take protective measurements, effectively prevent the network attack events and improve the network safety.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An analysis method for a network flow, comprising:
retrieving a source IP address and a destination IP address of the network flow;
determining whether the destination IP address qualifies a pre-determined condition or not; and
determining whether the source IP address is in a white list or the destination IP address is in an activity IP address list when the destination IP address does not qualify the pre-determined condition, so as to determine whether the network flow belongs to an attack behavior or not.

2. The analysis method of claim 1, further comprising:
determining whether the source IP address is in any IP reputation list or not;
directing the network flow to a honey pot system via an application interface when confirming that the source IP address is in the any IP reputation list; and
retaining the source IP address and the destination IP address in a database for reference when the source IP address is not in the any IP reputation list.

3. The analysis method of claim 1, wherein the pre-determined condition is that a packet per second, a flow count or a bit number received by the destination IP address exceeds a threshold.

4. The analysis method of claim 3, further comprising when the packet per second, the flow count or the bit number received by the destination IP address exceeds the threshold, sending out an alarm to inform a network operation center.

5. The analysis method of claim 1, wherein the step of determining whether the source IP address is in the white list or the destination IP address is in the activity IP address list when the destination IP address qualifies the pre-determined condition comprises:
informing a network operation center to clear a fault alarm when the source IP address is in the white list; and
confirming whether the destination IP address is in the activity IP address list or not when the source IP address is not included in the white list.

6. The analysis method of claim 5, wherein the step of confirming whether the destination IP address is in the activity IP address list or not when the source IP address is not included in the white list comprises:
confirming a serving domain of the destination IP address based on a lookup table to simultaneously analyze an access log corresponding to the serving domain.

7. The analysis method of claim 5, wherein the step of confirming whether the destination IP address is in the activity IP address list or not when the source IP address is not included in the white list comprises:
when the destination IP address is in the activity IP address list, calling an application delivery controller (ADC) via an application programming interface to automatically direct the network flow to a special network cluster and calling a router to adjust a routing table; and
when the destination IP address is not included in the activity IP address list, contacting a plurality of protection platforms via the application programming interface to activate an out-of-path (OOP) process.

8. The analysis method of claim 7, wherein the step of when the destination IP address is not included in the activity IP address list, contacting the plurality of protection platforms via the application programming interface to activate the out-of-path (OOP) process comprises:
determining whether the attack behavior is lasting or not, to contact the router via the application programming interface to adjust the network flow as an anti-hacking route, or to contact the router via the application programming interface to discard the network flow; and
retaining the source IP address and the destination IP address in a database for reference, when the attack behavior is not lasting.

9. A computer system, comprising:
at least a router, for determining a path of a network flow;
a collector, for collecting a destination IP address and a source IP address of the path of the network flow; and
an analyzer, for retrieving the source IP address and the destination IP address of the network flow, determining whether the destination IP address qualifies a pre-determined condition or not, and determining whether the source IP address is in a white list or the destination IP address is in an activity IP address list when the destination IP address does not qualify the pre-determined condition, so as to determine whether the network flow belongs to an attack behavior or not.

10. The computer system of claim 9, wherein the analyzer is utilized for determining whether the source IP address is in any IP reputation list or not, so as to direct the network flow to a honey pot system via an application programming interface when confirming that the source IP address is in the any IP reputation list, and retaining the source IP address and the destination IP address in a database for reference, when the source IP address is not in the any IP reputation list.

11. The computer system of claim 9, wherein the pre-determined condition is that a packet per second, a flow count or a bit number received by the destination IP address exceeds a threshold.

12. The computer system of claim 11, wherein the analyzer is utilized for sending out an alarm to inform a network operation center when the packet per second, the flow count or the bit number received by the destination IP address exceeds the threshold.

13. The computer system of claim 9, wherein when the destination IP address qualifies the pre-determined, the analyzer is further utilized for:
informing a network operation center to clear a fault when the source IP address is in the white list; and
confirming whether the destination IP address is in the activity IP address list or not when the source IP address is not included in the white list.

14. The computer system of claim 13, wherein when the source IP address is not included in the white list, the analyzer is further utilized for:
confirming a serving domain of the destination IP address based on a lookup table to simultaneously analyze an access log corresponding to the serving domain.

15. The computer system of claim 13, wherein when the source IP address is not included in the white list, the analyzer is further utilized for:
when the destination IP address is in the activity IP address list, calling an application delivery controller via an application programming interface to automatically direct the network flow to a special network cluster and calling a router to adjust a routing table; and
when the destination IP address is not included in the activity IP address list, contacting a plurality of protection platforms via the application programming interface to activate an out-of-path process.

16. The computer system of claim 15, wherein when the destination IP address is not included in the activity IP address list, the analyzer is further utilized for:
determining whether the attack behavior is lasting or not, to contact the router via the application programming interface to adjust the network flow as an anti-hacking route, or to contact one of the plurality of routers via the application programming interface to discard the network flow; and
retaining the source IP address and the destination IP address in a database for reference, when the attack behavior is not lasting.
